(19) United States
(12) Patent Application Publication
(10) Pub. No.: US 2003/0034106 A1
(43) Pub. Date: Feb. 20, 2003

(54) Rotatable component of a vehicle wheel

(75) Inventor: Jorge Lacayo-Pineda, Neustadt (DE)

Correspondence Address: ROBERT W. BECKER & ASSOCIATES, 707 Highway 66 East, Suite B, Tijeras, NM, 87059, US

(73) Assignee: Jorge Lacayo-Pineda to Continental Aktiengesselschaft, Hannover (DE)

(21) Appl. No.: 10/222,382

(22) Filed: Aug. 16, 2002

(30) Foreign Application Priority Data
Aug. 17, 2001 (DE) 101 40 515.4-21

(51) Int. Cl. B60C 13/00; B60C 13/04; B60B 21/00

(52) U.S. Cl. 152/523; 152/375

(57) ABSTRACT

A rotatable component of a vehicle wheel, especially, a vehicle tire or tire rim, includes, on a portion thereof which is preferably an outwardly visible portion, a pattern at least partially formed in an annular shape comprised of a composition of at least one contrast element serving as a reference and at least one group of further contrast elements.

### BACKGROUND OF THE INVENTION

The present invention relates to a rotatable component of a vehicle wheel, especially, a vehicle tire or tire or wheel rim, on which is provided, on an outwardly visible portion thereof, a pattern being at least partially formed in an annular shape.

In connection with vehicle tires, especially bicycle tires, tires for passenger automobiles, and commercial vehicles, it is customary to provide specifically configured or patterned displays on the sidewalls thereof which are optically appealing. Great care is typically given to the portrayal or exhibition of the trademarks and the manufacturer's name. Via further configured displays, the sidewalls of a vehicle tire are frequently provided with markings which are applied in a manner which respects aesthetic sensibilities to the greatest possible extent. It is, moreover, conventional to configure significantly large free surfaces of the sidewalls with top surface designs. Also, in the patent literature, various suggestions for configured displays on sidewalls can be found. Thus, for example, DE-A-28 55 700 discloses providing a top surface relief on the sidewalls of a vehicle tire wherein the relief comprises facets—that is, raised portions or projections and relief portions which extend parallel to one another. AT-B 397 373 discloses providing top surface areas on sidewalls comprised of a plurality of raised portions or projections collected together which extend substantially in the radial direction and converge toward the bead area in a fan-like manner.

It is also known to provide configured or dimensional elements on the sidewalls of tires in a contrasting color or in the color white—white sidewalls of tires come to mind in this connection. The production and fabrication of white color mixtures is possible in a relatively problem-free manner these days due to long experience in this area. The deployment of variously colored elastomeric mixtures for configuring tire sidewalls could not heretofore be implemented, in particular for the reason that significant efforts were required to provide such configurations.

### SUMMARY OF THE INVENTION

The present invention provides a solution to the challenge of providing the possibility to discover or propose an appealing configuration, especially a colored configuration, for vehicle tires and, as well, for other components of vehicle wheels such as, for example, wheel rims, which can be realized in an economically viable manner and which is clearly optically different than the heretofore known approaches.

The present invention provides a solution to the above-noted challenge in that patterns are provided comprised of compositions of at least one contrast element serving as a reference and at least one group of further contrast elements.

In accordance with the present invention, one such pattern is provided for a component of a vehicle wheel, especially, a tire or a wheel rim, which imparts, during rotational movement within a predetermined speed interval, a color effect which is dependent upon the structural division or partitioning of the pattern. The color perception of a rotating Benham-disc is related to a long-known optical illusion effect—the so-called Benham-Fechner flicker effect. The basis for the perception of color is that, shortly before reaching the so-called flicker fusion or blending frequency during change stimulation, the sensitivity for light intensity is stronger than it is by a comparable individual stimulation. The perception of the viewed object as colored depends upon the adaptation of the retina of the human eye. The perceived type of color depends upon the manner or style of the pattern and the course of the light stimulus and can be perceived differently by different people, as the physiological adaptation capability of the photoreceptors can be different. In accordance with the present invention, a pattern provided on a tire or tire rim can be configured such that it is, as well, visually appealing in the rest or non-rotating position of the component upon which the pattern is provided.

The annularly shaped pattern is comprised from the assembly or composition of at least one contrast element serving as a reference and at least one group of further contrast elements. A very simple pattern comprises only a reference element and a group of further contrast elements. In particular in connection with such a simply configured pattern, sufficient surface remains on the tire sidewall or the side surface of a tire rim to permit disposing thereon other design elements, text, and so forth adjacent to the inventive pattern.

In one preferred embodiment of the invention, the pattern is configured in the style of a Benham-disc pattern and, during the rotation, simulates at least one color in accordance with the principle of the Benham-Fechner effect. A pattern which is basically configured in accordance with this principle can be configured in various embodiments such that the pattern is also optically very appealing in the rest or non-rotating position of the component on which it appears.

If at least two groups of further contrast elements are provided, the pattern can be configured in a simple manner such that, during rotational movement thereof, more than two different colors can be perceived.

In this connection, it is especially advantageous if the pattern is so configured that the contrast elements within the group or groups of contrast elements, together with at least one contrast element serving as a reference, are arranged such that, during a rotational movement, the entirety of the contrast elements are perceivable as concentric annular rings. In this manner, tire sidewalls as well as the side surfaces of wheel rims can be perceived, during a rotational movement thereof, as having several differently colored annular rings.

Patterns which are particularly visually appealing in the rest or non-rotating position can be configured, for example, such that the, annular paths along which they rotate are preferably divided over their entire circumferences into, especially, an even number of identically dimensioned sectors, whereby every other sector is configured as a reference-serving contrast element and the group or, respectively, groups, of further contrast elements are arranged or mounted in the sectors between the reference-serving contrast elements.

The color perceptions produced by concentric rings extending around the circumference of a sidewall or a wheel rim side surface are particularly visually appealing. This effect can be achieved in a particularly effective manner by patterns which have the further contrast elements configured as small annular ring portions which extend concentrically around and into the annular pattern.

A perception of a color or colors at individual locations along the circumference of the rotating vehicle tire component is, in any event, possible if, for example, the further contrast elements are configured as small radially extending sector portions of the pattern ring.

If the entirety of the contrast elements are of the color black and disposed on a white background, the perception of color appears clearly and is particularly impressive.

The contrast elements themselves can be configured as structural elements such as, for example, flags, tails, etc., which opens further possibilities for optically appealing embodiments of an inventive pattern.

Further features, details, and advantages of the invention are described in more detail hereinafter in connection with the schematic drawings which show embodiments of the invention.

### BRIEF DESCRIPTION OF THE DRAWINGS

FIG. 1 is a plan view of a simple embodiment of a Benham-disc;

FIG. 2 is a variation of an embodiment of a pattern of the present invention;

FIGS. 2(a) and 2(b) are respective views of the perceived image of the pattern during a rotational movement thereof in a respective clockwise direction and a counter-clockwise direction; and

FIGS. 3-6 are different plan views of further embodiments of inventive patterns.

### DETAILED DESCRIPTION OF THE PREFERRED EMBODIMENT

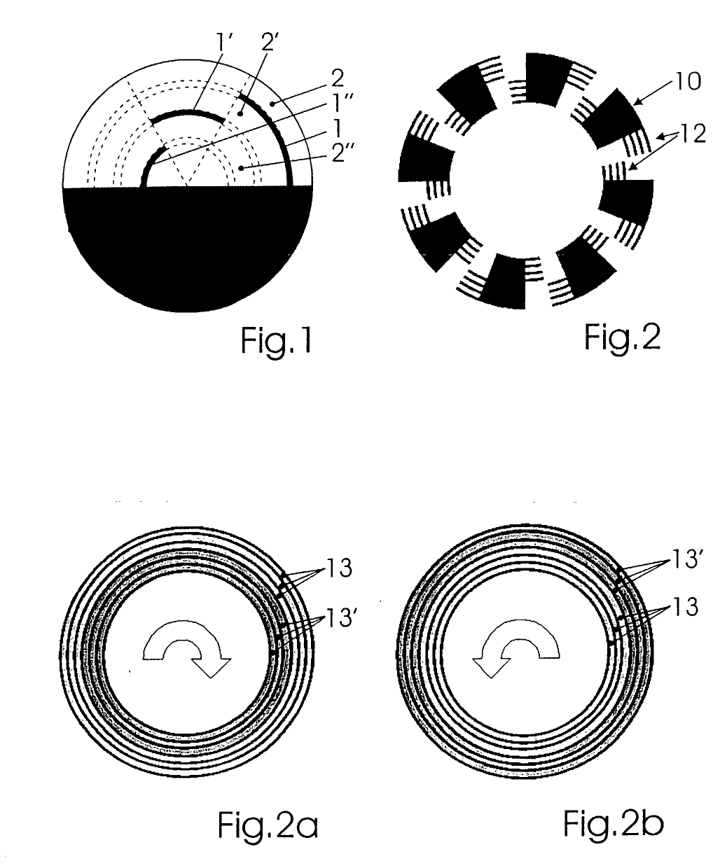

The present invention relates to a commercial use of patterns which produce the so-called pattern-induced flicker colors. The starting point of the invention is thus the well known color phenomena produced by a Benham-disc. An example of a very simple Benham-disc is shown in FIG. 1. One-half of the disc is black; the other half of the disc is white. The white half of the disc is partitioned into identically dimensioned or sized sectors, shown by the broken partitioning lines, and the small black annular elements 1, 1′, 1″ are provided at differing radial spacings from the midpoint of the disc, each of the ring elements extending in an arcuate manner in its respective sector. In the left hand sector is disposed the radially innermost ring element 1″, while in the right sector is disposed the ring element 1 at the radially outermost spacing from the midpoint of the disc.

The perception of a specific color is possible during a rotational movement of the disc in the clockwise direction at a flicker blending frequency. The small black ring elements 1, 1′, and 1″ produce, together with the black semi-annular half of the disc, an effect which is perceived as gray annular rings extending around the entire circumference of the disc, these gray annular rings being indicated in the white semi-annular half of the disc by the concentrically extending broken lines. The flicker blending for skoto optic viewing is, as a function of each observation, approximately between 5 and 12 Hertz (rotations of a point on the disc per second) while the flicker blending for photo optical viewing is between approximately 50 and 65 Hertz.

Different colors can be perceived in the areas between the gray appearing annular rings and areas outside of the outermost annular rings. The outermost ring 2 appears as a red color, each of the middle ring 2′appears as a green color, and the innermost ring 2″ appears as a blue color.

It is not yet fully known how these color perceptions actually come into being. It is known that the perception and the recognition of visual information occurs in the cerebrum and, indeed, in special areas thereof specific for certain components of visual information. In this connection, the perception of colors through light stimulus without hue (achromatic) is already stimulated by working steps in the retinal plane. The color phenomenon, which is produced by a rotating Benham-disc, is brought about as a function of the color constant property of the retina of the human eye. This also explains why the frequency at which the above-described color perception of a rotating Benham-disc occurs is not one exact frequency but, rather, lies within a frequency interval. The already mentioned flicker blending frequency is thus that particular frequency at which a discontinuous stimulus is received or perceived as a continuous constant stimulus.

Sample patterns for producing this optical illusion to effect the perception of color are comprised of at least two overlaid periods or overlapping periods of contrast elements, whereby at least one of the periods of contrast elements serves as a reference and at least one further period of contrast elements provides the optical illusion. The type of color can typically be differently perceived among different people especially with respect to the tint and intensity of the color, as the physiological capacity for adaptation of the receptors of the retina is individually different.

FIGS. 2-6 show examples of patterns as they are configured in accordance with the present invention in annular shapes on rotating components of vehicle wheels and, especially, the wheel rim or the vehicle tire.

The pattern shown in FIG. 2 is formed by the radial partitioning of an annular ring into sixteen identically dimensioned or sized annular ring sectors. Every second or every other annular sector—in total, eight sectors—is provided with black base elements 10 which, as described above, serve as reference periods of the contrast elements. In between the black base elements 10, in the remaining eight identically dimensioned or sized annular ring sectors which have white backgrounds, each sector thereof has a group of discrete black contrast elements 12 which correspond to further periods. In this connection, the white sectors are partitioned once again—this time, in the radial direction—into two identically sized or dimensioned portions, whereby one group of four black contrast elements 12 are arranged in each respective partitioned sector portion. In each partitioned sector portion, the four contrast elements 12 extend transversely through the sector portion concentric to one another and are spaced from one another in the radial direction as increasingly shorter ring elements.

Those contrast elements 12 extending in the clockwise direction from the base element 10 are in the radially outermost region of the contrast elements and are uniformly radially spaced from one another, while those contrast elements 12 extending in the counterclockwise direction from the base elements 10 are in the radially innermost region such that, as viewed in the circumferential direction, only those sector surfaces having white background are located next to these groups of contrast elements 12. If all of the contrast elements 12 were to completely traverse each white sector, they would form eight uniformly spaced complete black annular rings.

During a rotational movement of a component such as, for example, a wheel rim, which has these patterns disposed thereon, the observer perceives, shortly before reaching the flicker blending frequency, a certain color which is a respectively different color depending upon the direction of rotation.

FIGS. 2(a) and 2(b) are views of the pattern of the present invention provided to illuminate the color perception effects of the inventive pattern. In connection with a rotational movement in a clockwise direction, in the direction of the arrow shown in FIG. 2(a), the entirety of the contrast elements 12 together with the black base elements 10 are perceived as gray annular rings, whereby the outer three ring areas 13 between these gray rings appear as a blue color and the inner three ring areas 13′ appear as a red color. During a rotational movement in the counter-clockwise direction, in the direction shown by the arrow in FIG. 2(b), a color between the gray annular rings can be perceived as well shortly before reaching the flicker blending frequencies, whereby, in this instance, the three outer rings 13 appear as a red color and the three inner rings 13′ appear as a blue color.

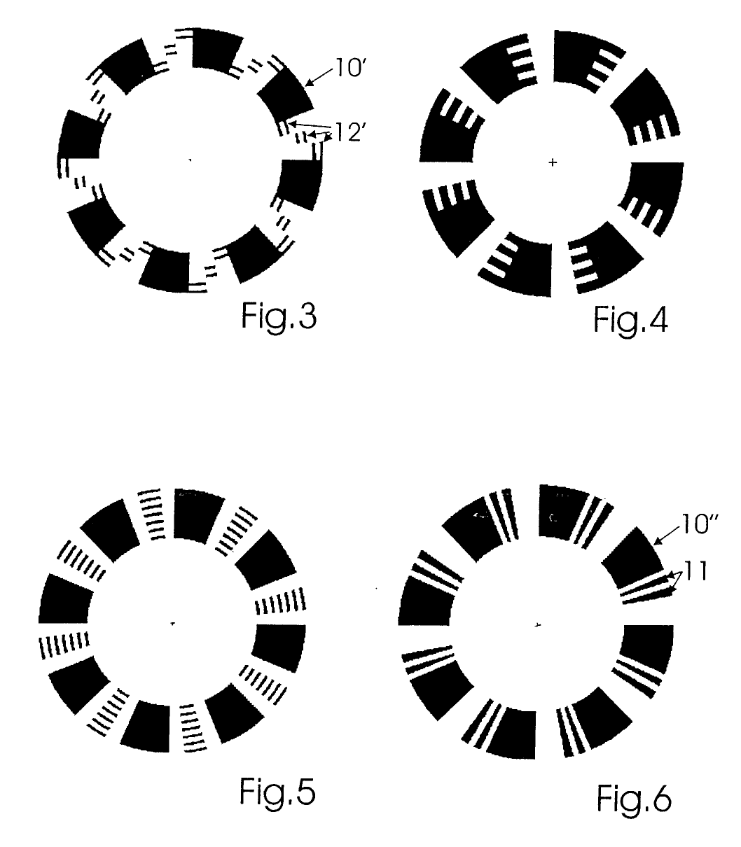

A further example of an inventive pattern is shown in FIG. 3. Here, as well, a pattern is produced along an annular ring, the pattern being formed by partitioning of the ring into sixteen identically dimensioned or sized annular ring sectors of which eight are configured as black base elements 10′. The remaining sectors disposed therebetween have white backgrounds and are partitioned, in the radial direction, into three portions, whereby, in each such partitioned sector portion, a respective group of two black contrast elements 12′ extend concentric to one another as annular ring elements traversing the respective partitioned sector portion. The sector portions bordering on the base elements 10′ are coincidental with one another and somewhat larger or, respectively, wider, than the middle sector portions. Those sector portions extending in the clockwise direction from the black base elements 10′ have two contrast elements 12′ at the radially innermost spacing; those extending from the base elements 10′ in a counter-clockwise direction have two contrast elements 12′ at a radially outermost spacing. In the middle sector portions, the contrast elements 12′ extend in a position between the other contrast elements 12′. The contrast elements 12′ overlap one another either in the radial direction or in the circumferential direction. During a rotational movement in the clockwise direction, six thin gray annular rings having therebetween two blue annular ring regions, a green ring region, and, on the outside, two red ring regions, can be perceived shortly before reaching the flicker blending frequency, as viewed from the inside towards the outside.

In the examples of the inventive pattern shown in FIGS. 4 and 5, a detailed description of the configuration of these patterns is omitted as the previously described patterns of elements have been slightly adapted to provide these further configurations.

It is solely mentioned that, in the embodiment of the pattern shown in FIG. 4, one can perceive, in accordance with the respective direction of rotation, a plurality of blue annular rings (rotation in a clockwise direction) or a plurality of red annular rings (rotation in a counter-clockwise direction.

In the embodiment of the pattern shown in FIG. 5, wherein concentrically extending black ring elements are provided in the middle of the white sectors, a mixed color effect occurs and the annular rings have the color green.

It is further to be mentioned that the contrast required for the color illusion can also be produced by an exchange or substitution of the white portions of the pattern with the black portions of the pattern. This can be easily imagined as one can picture, in the above-described examples, that the black portions are in the color white and the white portions are in the color black.

The illusion or, respectively, perception, of colors is adjustable, as well, by the deployment of patterns which are comprised solely of pattern building elements extending in the radial direction. An example of a pattern of this type is shown in FIG. 6. Here, as well, there is a partitioning of the pattern which extends along an annular path into sixteen identically dimensioned or sized sectors of which every other one is configured as a black base element 10″. Those sectors disposed between the base elements 10″ have white backgrounds and are each respectively interrupted by two small black radial sector portions 11. The small radial sector portions 11 are of differing width and converge, while being interrupted by small white intermediary spaces, on the black base elements 10″. During a rotational movement of this pattern in the clockwise direction, one can perceive, along the circumference, uniformly spaced green color locations embedded in a wide gray annular ring.

Other patterns in accordance with the present invention can be mounted on suitable vehicle wheels such as, for example, on wheel rims and tires of automobiles or two wheeled vehicles such as motorcycles, mopeds, etc., as well as on vehicle tires of non-motorized vehicles such as, for example, bicycle wheels. The wheel rims of vehicle wheels can be comprised of any desired materials such as, for example, wood, plastic, or metal; the vehicle wheels can be inflated tires or solid rubber tires comprised of rubber or plastic.

In connection with conventional vehicle tires or, respectively, pneumatic vehicle tires, whose sidewalls are comprised of black rubber material, the white regions thereof can be formed by the use of special elastomeric mixes, which produce the so-called white mixtures. The black elements of the patterns can be components of the respective sidewall mixtures which are deployed in the formation of the tire. In this manner, it can be provided that the black elements are integrated in a flush manner circumferentially around the sidewall or, as well, circumferentially configured patterns such as, for example, patterns configured by small white annular rings on the inside and outside, can be optically set off from the surrounding sidewall. The pattern can, additionally, be provided in an annular ring recess or relief in the tire or in an annularly configured region thereof. Additionally or alternatively, it can be provided that the black and/or white elements or parts thereof are configured as raised or recessed elements in contrast to other elements or are configured as circumferentially encircling surfaces of the component.

The lettering which is frequently provided on the sidewalls of vehicle tires in raised or relief areas can be configured as patterns and/or can be provided on surfaces which are free of a pattern. In connection with a bicycle tire, the side surfaces of the wheel rim, above all, are suitable for the disposition thereon of an inventive pattern. In accordance with the type of wheel rim or, as the case may be, the vehicle tire as well, it can be provided that the pattern is pre-finished and can be secured on the surface by adhesive or by vulcanization.

In connection with the use and arrangement of the pattern on vehicle tires, wheel rims, or, respectively, vehicle tires, it is of interest to initially determine or, respectively, estimate, how a pattern will be configured in order to create the desired illusion at a pre-determined vehicle speed or at a pre-determined vehicle speed interval. This can be set or predetermined by the choice of, and the taking into account of, the actual dimensions of the respective pattern, the number of white and black base elements along the circumference being considered, and the spacing of the pattern annular ring from the middle point and from the rotation axis of the vehicle tire. The physiological characteristics, which do not permit themselves to be varied and have been described hereinabove, must be taken into account in this connection. Generally, in connection with patterns which extend in annular rings having coincidental radii, a non-refined structure, a reduced number of white and black sectors along the circumference, and an increased rotational speed are required to effect the color illusion in comparison to a finely partitioned structure having a greater number of black and white sectors. The individual base elements can, in this connection, also be configured as structural elements such as, for example, flags, tails, etc. or can be configured to simulate such diverse structural elements, to the extent that the basic requirements for the creation of a color illusion are taken into account.

The specification incorporates by reference the disclosure of German priority document 101 40 515.4-21 filed Aug. 17, 2001.

The present invention is, of course, in no way restricted to the specific disclosure of the specification and drawings, but also encompasses any modifications within the scope of the appended claims.

What is claimed is:

1. A rotatable component of a vehicle wheel, especially, a vehicle tire or wheel rim, comprising, on a portion thereof which is preferably an outwardly visible portion, a pattern at least partially formed in an annular shape comprised of a composition of at least one contrast element serving as a reference and at least one group of further contrast elements.

2. A rotatable component of a vehicle wheel according to claim 1, wherein the pattern is configured in the style of a Benham-disc and, during the rotation, simulates at least one color in accordance with the principle of the Benham-Fechner effect.

3. A rotatable component of a vehicle wheel according to claim 1, wherein the pattern includes a composition of at least one group of the contrast elements serving as reference elements and at least one group of further contrast elements which correspond to a further period.

4. A rotatable component of a vehicle wheel according to claim 1, wherein the pattern includes at least two groups of further contrast elements.

5. A rotatable component of a vehicle wheel according to claim 1, wherein the contrast elements within the group or groups of further contrast elements are arranged together with at least one contrast element serving as a reference such that, during a rotational movement, the entirety of the contrast elements are perceivable as concentric annular rings.

6. A rotatable component of a vehicle wheel according to claim 1, wherein the pattern is formed by radially partitioning the pattern around its entire annular circumference into identically dimensioned or sized annular ring sectors with every second annular ring sector being configured as a base element which serves as reference.

7. A rotatable component of a vehicle wheel according to claim 6, wherein the at least one group of further contrast elements are arranged in at least one of a radially and a circumferentially coincidental manner with one another in the respective sectors between the sectors in which the base contrast elements are located.

8. A rotatable component of a vehicle wheel according to claim 6, wherein the at least one group of further contrast elements are configured as relatively small annularly extending segments which extend concentrically to one another around the pattern.

9. A rotatable component of a vehicle wheel according to claim 6, wherein the at least one group of further contrast elements are configured as relatively small radially extending sector portions of the pattern.

10. A rotatable component of a vehicle wheel according to claim 6, wherein the entirety of the at least one reference contrast element and the at least one group of further contrast elements are configured as black elements disposed on a white background.

11. A rotatable component of a vehicle wheel according to claim 1, wherein the contrast elements are configured as structural elements such as flags, tails, etc. or elements which simulate flags, tails, etc . . .

12. A rotatable tire of a vehicle wheel, comprising, on a sidewall thereof, a pattern at least partially formed in an annular shape comprised of a composition of at least one contrast element serving as a reference and at least one group of further contrast elements.

13. A rotatable wheel rim of a vehicle wheel, comprising, on a side thereof having an outwardly visible rim surface, a pattern at least partially formed in an annular shape comprised of a composition of at least one contrast element serving as a reference and at least one group of further contrast elements.
